(19) United States
(12) Patent Application Publication
(10) Pub. No.: US 2007/0041806 A1
(43) Pub. Date: Feb. 22, 2007

(54) Fastening device

(75) Inventor: Robert J. Wahls, Pinckney, MI (US)

Correspondence Address: YOUNG & BASILE, P.C., 3001 WEST BIG BEAVER ROAD, SUITE 624, TROY, MI, 48084, US

(73) Assignee: Michigan Seat Company

(21) Appl. No.: 11/205,552

(22) Filed: Aug. 17, 2005

(51) Int. Cl. F16B 39/00

(52) U.S. Cl. 411/166

(57) ABSTRACT

A fastening device for engaging a structure is disclosed. The device has a collar having a passageway for receiving a fastener therethrough, and a flange connected to the collar and having first and second portions, wherein the flange is engageable with the structure. The device has an uninstalled position, wherein the first and second portions of the flange are substantially non-coplanar with respect to each other, and an installed position, wherein the first and second portions of the flange are substantially coplanar with respect to each other. The present invention further comprises the first and second portions of the flange having serrated or toothed edges engageable with the structure. The collar may be substantially tubular. The present invention may further provide threads in the passageway of the collar for receiving a threaded fastener therethrough.

### FIELD OF THE INVENTION

The present invention relates to a fastening device, and more particularly, a fastening device useable for securing a tractor seat to the chassis of a tractor.

### BACKGROUND OF THE INVENTION

Motorized tractors have been a part of the agricultural and domestic landscape ever since the advent of the mechanical engine. Wheeled and treaded tractors have come in an array of shapes and sizes over the years, but one constant among all tractor designs has been the need to interface with a human operator. There have been a number of ways to provide such interfaces. Nevertheless, in tractors designed for both agricultural and domestic uses, history has favored a seated arrangement for a human operator.

As with the bodies of tractors themselves, seats constructed from metal seat pans have long been the practice for accommodating human users in both agricultural and domestic tractors. Over the years, those skilled in the art have developed various modifications to metal seat pans and metal seat pan mounts to improve the level of comfort provided to the end user. Such improvements have included a variety of conforming and ergonomic shapes, as well as shock-absorbing or spring-mounted seats to attenuate the vibrations and jarring that are part and parcel of agricultural and domestic tractor environments. While such improvements have been useful over the years, the cost of steel has recently suffered sharp increases, leading those skilled in the art to seek alternative materials for seat pan structures.

The development of widely available and inexpensive commercial plastics have offered workable alternative structures to metal seat pan structures. The use of these plastics has also brought new design challenges. In particular, mounting hardware for metal seat pan structures have included such devices as weld nuts and pierce nuts. Such dedicated nuts are only usable with metal and cannot be employed with hard plastics. Plastics obviously cannot be welded, and pierce nuts generally require that the material to which they are mounted be malleable. Further, threads molded or formed in plastics can increase the expense associated with plastic production, and such molded threads may fail when used in conjunction with some hard or brittle plastics.

Thus, it would be desirable to have a device capable of permanently securing a structure such as a plastic seat pan to the chassis of a tractor or other vehicle.

### SUMMARY OF THE INVENTION

The present invention provides a fastening device for engaging a structure. The device provides a collar having a passageway for receiving a fastener therethrough. A flange is connected to the collar and has first and second portions, wherein the flange is engageable with the structure. The device has an uninstalled position, wherein the first and second portions of the flange are substantially non-coplanar with respect to each other, and an installed position, wherein the first and second portions of the flange are substantially coplanar with respect to each other. The present invention further provides the first and second portions of the flange having serrated or toothed edges engageable with the structure. The collar may be substantially tubular and may provide threads in the passageway of the collar for receiving a threaded fastener therethrough. The device is receivable in a slot of the structure wherein the slot provides opposing first and second walls, wherein in the installed position, the first portion of the flange is engageable with the first wall of the slot, and the second portion of the flange is engageable with the second wall of the slot.

### BRIEF DESCRIPTION OF THE DRAWINGS

The description herein makes reference to the accompanying drawings wherein like reference numerals refer to like parts throughout several views and wherein:

FIG. 1 is a perspective view of the fastening device of the present invention for engaging a structure showing the present invention in use with a tractor seat.

FIG. 2 is a perspective view of the fastening device of the present invention for engaging a structure wherein the apparatus is in an uninstalled position.

FIG. 3 is a front elevation view of the fastening device of the present invention for engaging a structure wherein the apparatus is in the uninstalled position.

FIG. 4 is a side elevation view of the fastening device of the present invention for engaging a structure wherein the apparatus is in the uninstalled position.

FIG. 5A is a partially cut away plan view of the fastening device of the present invention for engaging a structure showing the present invention in the uninstalled position.

FIG. 5B is a front elevation cut away view taken along line 5B-5B of FIG. 5A of the fastening device of the present invention for engaging a structure showing the present invention in the uninstalled position.

FIG. 6A is a partially cut away plan view of the fastening device of the present invention for engaging a structure showing the apparatus in the installed position.

FIG. 6B is a front elevation cut away view taken along line 6B-6B of FIG. 6A of the fastening device of the present invention for engaging a structure showing the apparatus in the installed position.

### DESCRIPTION OF THE PREFERRED EMBODIMENTS

Referring to the drawings, the present invention will now be described in detail with reference to the disclosed embodiments.

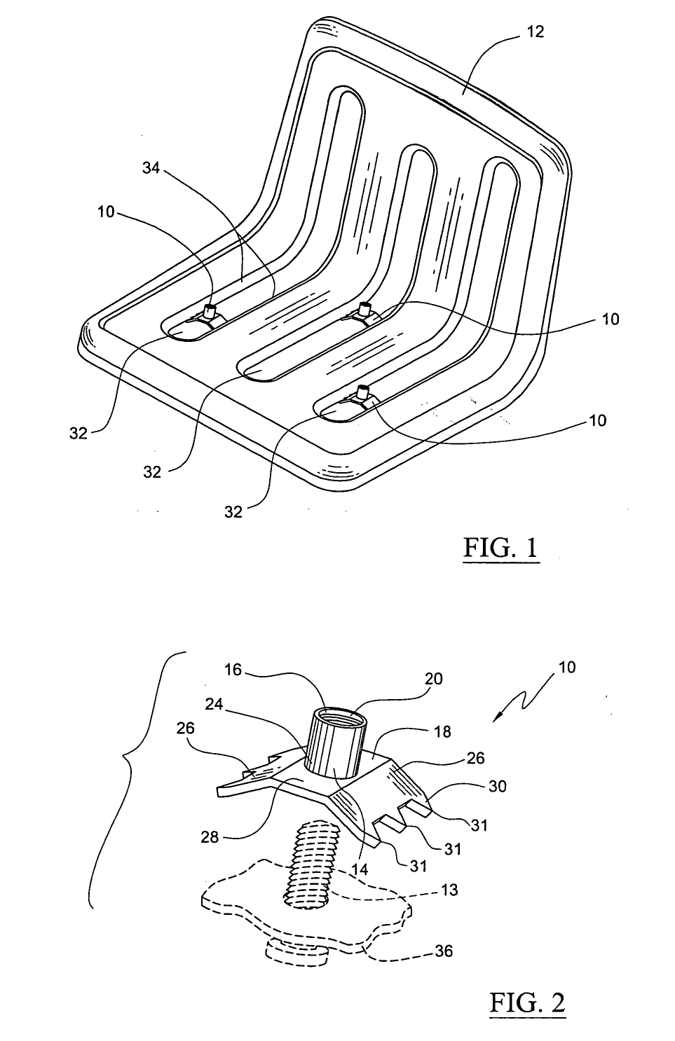

FIGS. 1-6B illustrate a fastening device 10 for engaging a structure 12, such as a seat pan. It will be appreciated that the device 10 is not limited to use with seat pans, but may be used to engage a variety of other structures.

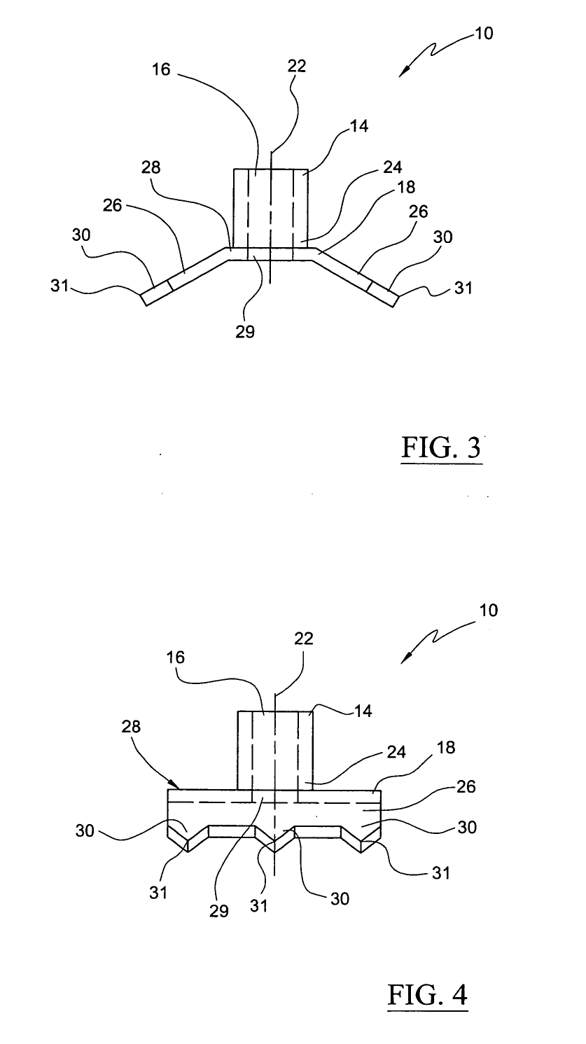

In order to receive a fastener 13, such as a bolt, screw, rivet, or other such fastener, the device 10 for engaging a structure 12 has a collar 14 defining a passageway 16 therethrough. The collar 14 is connected to a flange 18 that contacts and engages the structure 12. Threads 20 may be provided within passageway 16 in order to threadably engage a threaded fastener 13. The collar 14 is substantially tubular in shape; however, the collar 14 may have any exterior shape to accommodate ease in manufacturing or installation. Similarly, the passageway 16 may be made in any shape in order to accommodate specific fasteners 13. A substantially tubular or cylindrical passageway 16 is suitable for accommodating threaded fasteners 13, such as screws and bolts, or non-threaded fasteners, such as nails, rivets, or the like (not shown). The collar 14 has a longitudinal axis 22, as shown in FIGS. 3 and 4, and a flange end 24, as seen in FIGS. 2-4. The collar 14 and threads 20 may be constructed from any type of various metals, plastics, woods, or other substantially rigid materials suitable for engaging threaded or non-threaded fasteners.

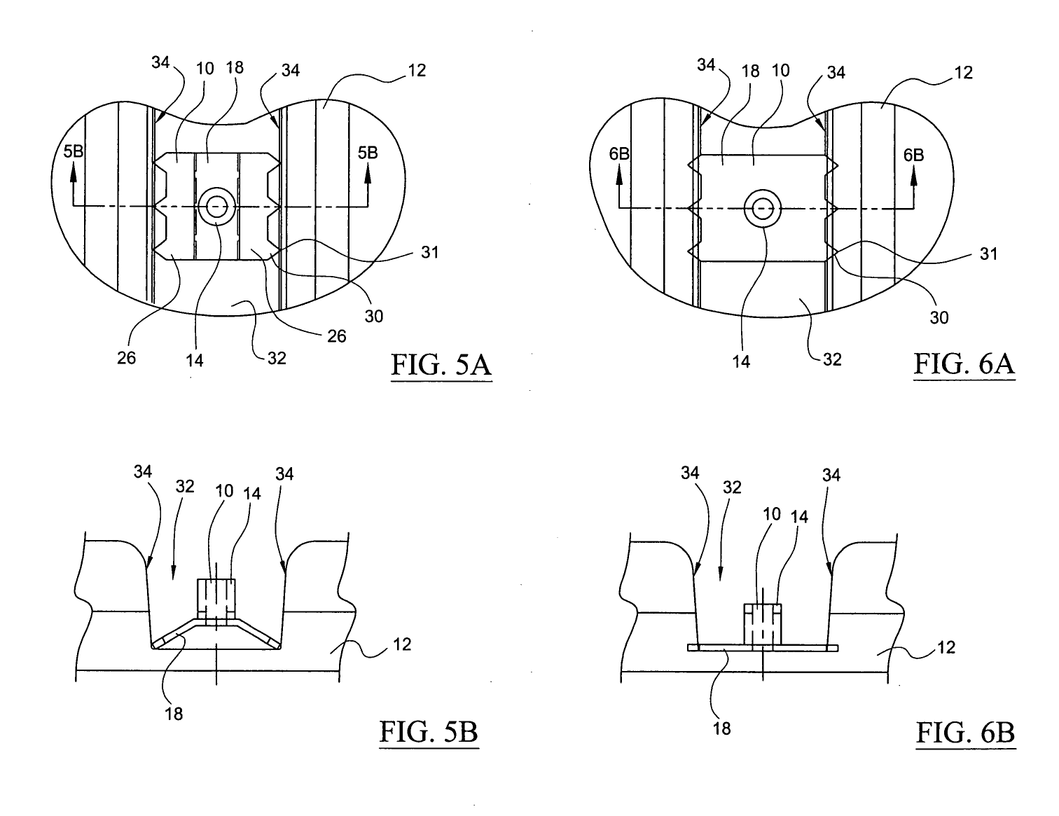

In order for the device 10 to engage the structure 12, a flange 18 is integrally connected to and extends outwardly from the flange end 24 of the collar 14 wherein both the flange 18 and the collar 14 are formed as one piece. Alternatively, the flange 18 may be fixedly connected to the flange end 24 of the collar 14 by way of welding, soldering, or adhesives. As a further alternative, the flange 18 may be removably connected to the flange end 24 of the collar 14 with a press fit, threaded, or similar joint. As can best be seen in FIG. 5A, the flange 18 has a substantially rectangular shape. The flange 18 is connected to the collar 14 such that the longitudinal axis 22 of the collar 14 is substantially normal to the plane of the flange 18. As can be seen in FIGS. 1-5B, the device 10 is in an uninstalled position when end portions 26 of the flange 18 are bent or otherwise disposed at a substantially obtuse angle with respect to a central portion 28 of the flange 18 such that end portions 26 extend slightly away from the side of the flange 18 that connects to the flange end 24 of the collar 14. In order to accommodate the fastener 13, the central portion 28 of the flange 18 further defines a passageway 29 in substantial alignment with the passageway 16 defined by the collar 14. The collar 14 is disposed on substantially one side of the flange 18 such that the device 10 has the overall appearance of an inverted T-shape.

In order for the device 10 to securely engage the structure 12, three teeth 30 are formed in each of the end portions 26 of the flange 18. Each tooth 30 is integrally formed with and extends from the end portions 26 of the flange 18. Each tooth 30 provides a sharp point 31 to penetrate the structure 12, such as a structure made of a hard plastic, metal, or wood material. Although three teeth 30 are depicted on each of the end portions 26 of the flange 18, a greater number or lesser number of teeth 30 may be provided on either of end portions 26 in order to suit particular applications or structures into which the device 10 is to be engaged. Alternatively, instead of one or more teeth 30 provided on each of end portions 26, each of end portions 26 may terminate in a roughened or serrated edge (not shown) similarly capable of engaging the structure 12 as teeth 30.

The flange 18 may be constructed from any type of various metals or plastics that are substantially rigid and hard enough to penetrate plastics and metals found in seat pan structures, yet capable of deforming slightly with the application of slight or moderate force. As described above, the flange 18 may be formed integrally with the collar 14 or may be fixedly or removably attached to the collar 14 through a variety of means. Although in the embodiments shown in FIGS. 1-6B, the flange 18 has a substantially rectangular shape, the flange 18 may be constructed in various sizes and shapes in order to correspond to specific applications or environments.

To engage the structure 12, the flange 18 moves from the uninstalled position, depicted in FIGS. 5A-5B, to an installed position, depicted in FIGS. 6A-6B. As described above, in the uninstalled condition, the end portions 26 of the flange 18 extend at an obtuse angle with respect to the central portion 28 of the flange 18. This allows the device 10 to be inserted into a slot 32 or other area in the structure 12 such that the device 10 does not immediately engage walls 34 or other portions of the structure 12. In the installed position, the flange 18 is substantially flat, as depicted in FIGS. 6A-6B, and both the end portions 26 and central portion 28 of the flange 18 are substantially coplanar with each other. Further, the teeth 30 of the flange 18 are engaged with portions of the walls 34 of the slot 32 located in the structure 12 when the flange 18 and device 10 are in the installed position. In the installed position, the teeth 30 are substantially embedded in the walls 34 of the slot 32 of the structure 12 to secure the device 10 to the structure 12.

In operation, a person installing a tractor seat or other structure 12 takes one or more of the fastening devices 10 and inserts them into one or more slots 32 provided in the structure 12, as depicted in FIG. 1. The precise locations of the devices 10 in relation to the slots 32 and structure 12 depend upon the particular installation arrangement of the structure 12 as it may be mounted on a tractor chassis or other structure 36. Each of the devices 10 should be installed in a slot 32 or other locale within the structure 12 such that the teeth 30 of the flange 18 are poised to engage walls 34 or other analogous portions of the structure 12, as depicted in FIGS. 5A-5B. Once the devices 10 are positioned in this way, each device 10 is struck with a hammer or other impact-imparting apparatus (not shown) so that the device 10 achieves the installed position, as depicted in FIGS. 6A-6B. The force provided by the impact-imparting apparatus may be applied to the portion of the collar 14 located away from the flange end 24 of the collar 14, or, alternatively, the impact-imparting apparatus may have a recess to accommodate the collar 14 and a surface that substantially engages the central portion 28 of the flange 18 when imparting a force to the device 10 which takes it from the uninstalled position, as depicted in FIGS. 5A-5B, to the installed position, as depicted in FIGS. 6A-6B. As a further alternative, the device 10 may be installed concurrently with the installation of the fastener 13, as with the tightening of a bolt or in installing a rivet. Regardless of the particular method used for installing the device 10 such that it engages the structure 12, the goal of such an installation operation is to achieve a substantially coplanar orientation of the end portions 26 and central portion 28 of the flange 18 such that the teeth 30 provided on the end portions 26 of the flange 18 substantially engage the walls 34 of the slot 32 of the structure 12. In this way, the device 10 has substantially no freedom of movement within the slot 32 of the structure 12. The fastener 13, if not installed concurrently with the device 10, is later inserted through the passageway 16, engaging threads 20 if provided, and further connects to a corresponding structure 36 provided in conjunction with the chassis of a tractor or other device on which the structure 12 is to be mounted. The device 10 will not become loosened or freed with the application of continuous vibrations and random forces of varying frequencies and magnitudes transmitted to the device 10 through the fastener 13.

While the fastening device 10 of the present invention has been developed in conjunction with such structures 12 as seat pans for use on tractors and other vehicles, such devices 10 may also be used with structures far afield of the seating arts. Further, while the invention has been described in connection with what is presently considered to be the most practical and preferred embodiments, it is to be understood that the invention is not to be limited to the disclosed embodiments. To the contrary, this disclosure is intended to cover various modifications or equivalent arrangements included within the spirit and scope of the appended claims. The scope is to be accorded the broadest interpretation so as to encompass all such modifications and equivalent structures as is permitted under the law.

Accordingly, I claim:

1. A fastening device, comprising:
a collar defining a passageway;
a flange connected to the collar and having first and second portions, wherein the flange is engageable with a structure; and
the flange having an uninstalled position, wherein the first and second portions of the flange are substantially non-coplanar with respect to each other, and an installed position, wherein the first and second portions of the flange are substantially coplanar with respect to each other.

2. The fastening device of claim 1, further comprising:
the first and second portions of the flange having serrated edges engageable with the structure.

3. The fastening device of claim 1, further comprising:
the first and second portions of the flange having toothed edges engageable with the structure.

4. The fastening device of claim 1, further comprising:
the collar being substantially tubular.

5. The fastening device of claim 1, further comprising:
threads provided in the passageway of the collar.

6. The fastening device of claim 1, further comprising:
the flange receivable in a slot of the structure wherein the slot provides a first wall and an opposing wall, wherein in the installed position, the first portion of the flange is engageable with the first wall of the slot, and the second portion of the flange is engageable with the second wall of the slot.

7. A fastening device, comprising:
a collar defining a passageway for receiving a fastener therethrough;
a flange having a first portion connected to the collar and two end portions engageable with a structure; and
the flange having an uninstalled position, wherein the end portions of the flange are substantially non-coplanar with respect to each other and with respect to the first portion of the flange, and an installed position, wherein the end portions are substantially coplanar with respect to each other and with respect to the first portion of the flange.

8. The fastening device of claim 7, further comprising:
the first portion and the end portions of the flange defining a substantially arcuate shape when the device is in the uninstalled position.

9. The fastening device of claim 7, further comprising:
the end portions of the flange each forming a substantially obtuse angle with respect to the first portion of the flange when the device is in the uninstalled position.

10. The fastening device of claim 7, further comprising:
the end portions of the flange having serrated edges engageable with the structure.

11. The fastening device of claim 7, further comprising:
the end portions of the flange having toothed edges engageable with the structure.

12. The fastening device of claim 7, further comprising:
the collar being substantially tubular.

13. The fastening device of claim 7, further comprising:
threads provided in the passageway of the collar for receiving a threaded fastener therethrough.

14. The fastening device of claim 7, further comprising:
the flange receivable in a slot of the structure wherein the slot provides a first wall and an opposing wall, wherein in the installed position, the end portions of the flange are engageable with the first and second walls of the slot.

15. A fastening device, comprising:
a substantially tubular collar having a longitudinal axis, a flange end, and a passageway substantially coaxial with the longitudinal axis for receiving a fastener therethrough;
a substantially rectangular, substantially planar first flange portion connected to the flange end of the collar wherein the longitudinal axis of the collar is substantially normal to the first flange portion, and the first flange portion has a passageway substantially aligned with the passageway in the collar for receiving the fastener therethrough;
substantially planar second and third flange portions each integrally connected to the first flange portion and each having a plurality of teeth engageable with a structure; and
the flange having an uninstalled position, wherein the second and third flange portions are substantially non-coplanar with respect to each other and with respect to the first flange portion, and an installed position, wherein the second and third flange portions are substantially coplanar with respect to each other and with respect to the first flange portion.

16. The fastening device of claim 15, further comprising:
the second and third flange portions each forming a substantially obtuse angle with respect to the first flange portion when the device is in the uninstalled position.

17. The fastening device of claim 15, further comprising:
threads provided on the passageway of the collar for receiving a threaded fastener therethrough.

18. The fastening device of claim 15, further comprising:
the flange receivable in a slot of the structure wherein the slot provides a first wall and an opposing second wall, wherein in the installed position, the second portion of the flange is engageable with the first wall of the slot and the third portion of the flange is engageable with the second wall of the slot.

19. The fastening device of claim 15, further comprising:
the fastener being connectable to a second structure.
